(19) United States
(12) Patent Application Publication
(10) Pub. No.: US 2009/0074343 A1
(43) Pub. Date: Mar. 19, 2009

(54) Vehicle Wheel Bearing Apparatus

(75) Inventors: Shinji Morita, Iwata-Shi (JP); Takayuki Norimatsu, Iwata-Shi (JP); Akira Fujimura, Iwata-Shi (JP)

Correspondence Address: HARNESS, DICKEY & PIERCE, P.L.C., P.O. BOX 828, BLOOMFIELD HILLS, MI, 48303, US

(73) Assignee: NTN Corporation, Osaka (JP)

(21) Appl. No.: 12/269,906

(22) Filed: Nov. 13, 2008

Related U.S. Application Data
(63) Continuation of application No. PCT/JP2007/000513, filed on May 14, 2007.

(30) Foreign Application Priority Data
May 15, 2006 (JP) 2006-135400
May 15, 2006 (JP) 2006-135401

(51) Int. Cl. F16C 19/38

(52) U.S. Cl. 384/548

(57) ABSTRACT

A vehicle wheel bearing apparatus has an outer member on its inner circumference with double row tapered outer raceway surfaces arranged so that each smaller diameter side faces toward each other. An inner member includes a wheel hub and an inner ring. The wheel hub has an integrally formed wheel mounting flange. Its outer circumference has one inner raceway surface arranged opposite to one of the double row outer raceway surfaces. A cylindrical portion axially extends from the inner raceway surface. The inner ring is fit onto the cylindrical portion of the wheel hub, via a predetermined interference. The inner ring outer circumference has another inner raceway surface arranged opposite to the other of the double row outer raceway surfaces. Double row tapered rollers are freely rollably contained between the inner and outer raceway surfaces, respectively, of the inner member and the outer member. Seals are mounted in annular openings formed between the outer member and the inner member. The inner ring is formed with a large flange on its larger diameter side of the inner raceway surface. The larger flange guides the inner side tapered rollers of the double row tapered rollers. A flange ring is fit onto the wheel hub at a place adjacent to the wheel mounting flange to guide the outer side tapered rollers of the double row tapered rollers. The flange ring abuts against and guides the larger end faces of the outer side tapered rollers. A pitch circle diameter of a row of outer side tapered rollers is set larger than a pitch circle diameter of a row of inner side tapered rollers.

### CROSS-REFERENCE TO RELATED APPLICATIONS

This application is a continuation of International Application No. PCT/JP2007/000513, filed May 14, 2007, which claims priority to Japanese Application Nos. 2006-135400, filed May 15, 2006 and 2006-135401, filed May 15, 2006. The disclosures of the above applications are incorporated herein by reference.

### FIELD

The present disclosure relates to a bearing apparatus that freely rotationally supports a wheel of a vehicle, a wheel bearing apparatus and, more particularly, to a wheel bearing apparatus with a double row tapered roller bearing that rotationally supports a wheel of heavy duty vehicles, such as trucks and wagons etc.

### BACKGROUND

In vehicles, such as trucks, their engine power or carrying capacity has been increased. Thus, there is a desire that the wheel bearing apparatus is durable against rising temperatures during heavy load and high speed travel. A bearing for the wheel bearing apparatus in such a vehicle is a double row tapered roller bearing. The double row tapered roller bearing has been generally used to support the radial load, thrust load and the combined load.

One example of a wheel bearing apparatus using such a double row tapered roller bearing is shown in FIG. 3. The wheel bearing apparatus is adapted to be mounted on an axle of a driven wheel of a vehicle, such as a truck, to freely rotationally support a wheel (not shown). In the description below, the term “outer side” defines a side that is positioned outside of a vehicle body (left-hand side in drawings). The term “inner side” defines a side that is positioned inside of the vehicle body (right-hand side in drawings) when the bearing apparatus is mounted on the vehicle body.

The wheel bearing apparatus has an outer member 51 formed with double row outer raceway surfaces 51a, 51a on its inner circumference. The double row tapered outer raceway surfaces 51a, 51a are arranged so that each smaller diameter side faces the other. An inner member 52 is formed with double row inner raceway surfaces 58a, 59a on its outer circumference. The inner raceway surfaces 58a, 59a are arranged opposite to the double row tapered outer raceway surfaces 51a, 51a, respectively. Double row tapered rollers 54, 54 are freely rollably contained between the inner and outer raceway surfaces, via cages 53. Seals 55, 56 are mounted within annular openings formed between the outer member 51 and the inner member 52. Sealing members 55a, 56a are fit in both ends of the outer member 51. Slingers 55b, 56b slidably contact the sealing members 55a, 56a to prevent leakage of lubricating grease sealed within the bearing and the entry of rain water or dusts into the bearing from the outside.

The inner member 52 has a wheel hub 58 and an inner ring 59. The wheel hub 58 has an integrally formed wheel mounting flange 57 at its outer side end. An outer side inner raceway surface 58a is formed on the wheel hub 58. A cylindrical portion 58b axially extends from the inner raceway surface 58a. The inner ring 59 is formed with the other inner side inner raceway surface 59a on its outer circumference. It is axially secured on the wheel hub 58 by a caulked portion 60 that is formed by radially outwardly plastically deforming an end of the cylindrical portion 58b.

Bolt apertures 57a are equidistantly arranged on the wheel mounting flange 57 along its periphery of the wheel hub 58. Securing bolts (not shown) are used to fasten a wheel thereon. In addition, a flange ring 61 is fitted on the wheel hub 58 at the base of the wheel mounting flange 57. The flange ring 61 abuts against a larger end faces of the outer side tapered rollers 54.

The inner ring 59 is formed on its larger diameter side of the inner raceway surface 59a with a larger flange 59b. The larger end surfaces of the inner side tapered rollers 54 abut and are guided along the larger flange 59b. A smaller flange 59c is formed on the smaller diameter side of the inner raceway surface 59a. The smaller flange 59c prevents the tapered rollers 54 from falling out. In addition, a slinger 56b, forming the inner side seal 56, is fit onto the outer circumference of the larger flange 59b of the inner ring 59.

A cylindrical fitting surface 62 is formed on the outer circumference adjacent to the wheel mounting flange 57 of the wheel hub 58. The flange ring 61 is fit onto the cylindrical fitting surface 62. A surface portion 63, having a circular arc cross-section, is formed continuously from the flange ring fitting surface 62 to the side face of the wheel mounting flange 57. The flange ring 61 has a flange surface 61a that abuts and guides the larger end face of the outer side tapered rollers 54. A cylindrical inner circumference 61b, an end face 61c abutting against the side face of the wheel mounting flange 57, and a circular arc portion 61d are formed so that it extends from the end face 61c to the inner circumference 61b so as not to be contacted by the circular arc portion 63 of the wheel hub 58. The outer circumference of the flange ring 61 is formed as a stepped cylindrical surface. Thus, it has a larger diameter potion at a side of the wheel mounting flange 57 and a smaller diameter portion 61e on which a slinger 55b, forming the outer side seal 55, is fitted.

According to this wheel bearing apparatus, a larger flange conventionally formed on the larger diameter side of the inner raceway surface 58a of the wheel hub 58 is omitted. Instead, the flange ring 61 is fit onto the outer circumference adjacent to the wheel mounting flange 57 of the wheel hub 58 as a separate member from the wheel hub 58. Thus, it is possible to suppress stress concentration that would be caused at a region near a boundary between the inner raceway surface 58a and the flange surface 61a of the flange ring 61 by contact of the tapered rollers 54 with the boundary region. Thus, the wheel bearing apparatus can exhibit an excellent durability against fatigue caused in a region near the boundary region although it is applied to a heavy duty vehicle. The circular arc portion 61d of the flange ring 61 does not contact the circular arc portion 63 of a large radius of curvature continuous to the side face of the wheel mounting flange 57. Thus, it is possible to further reduce the stress concentration caused by the load applied by the tapered rollers 54 via the flange ring 61 (see Japanese Laid-open Patent Publication No. 340242/2004).

### SUMMARY

The prior art wheel bearing apparatus includes the flange ring 61 to guide the tapered rollers 54 instead of the larger flange conventionally formed on the outer side of the inner raceway surface 58a. The flange ring 61 is fit onto the outer circumference of wheel hub 58 adjacent to the wheel mounting flange 57. Thus, it is possible to reduce the stress concentration caused on the wheel hub 58 and to improve the durability of the wheel bearing apparatus. However, in the prior art wheel bearing apparatus, it is desired to further increase the rigidity of the wheel bearing apparatus while suppressing the increase of its weight.

It is, therefore, an object of the present disclosure to provide a wheel bearing apparatus that exhibits excellent durability and increases its rigidity while suppressing an increase of its weight.

A vehicle wheel bearing apparatus comprises an outer member formed with double row tapered outer raceway surfaces on its inner circumference. The double row tapered outer raceway surfaces are arranged so that each smaller diameter side faces each other. An inner member includes a wheel hub and an inner ring. The wheel hub has an integrally formed wheel mounting flange. Its outer circumference surface has one inner raceway surface arranged opposite to one of the double row outer raceway surfaces. A cylindrical portion axially extends from the inner raceway surface. The inner ring is adapted to fit onto the cylindrical portion of the wheel hub, via a predetermined interference. The inner ring is formed with the other inner raceway surface on its outer circumference. The inner raceway surface is arranged opposite to the other of the double row outer raceway surfaces. Double row tapered rollers are freely rollably contained between the inner and outer raceway surfaces, respectively, of the inner member and the outer member. Seals are mounted in annular openings formed between the outer member and the inner member. The inner ring is formed with a larger flange on its larger diameter side of the inner raceway surface. The larger flange guides the inner side tapered rollers of the double row tapered rollers. A flange ring is fit onto the wheel hub at a place adjacent to the wheel mounting flange to guide the outer side tapered rollers of the double row tapered rollers. The flange ring abuts against the larger end faces of the outer side tapered rollers and guides the outer side tapered rollers. A pitch circle diameter of a row of outer side tapered rollers is set larger than a pitch circle diameter of a row of inner side tapered rollers.

The wheel bearing apparatus has a double row tapered roller bearing. The flange ring is separate from the wheel hub and is fit onto the outer circumference of the wheel hub adjacent to the wheel mounting flange. The pitch circle diameter of the row of outer side tapered rollers is set larger than that of a row of the inner side tapered rollers. Thus, it is possible to arrange a larger number of outer side tapered rollers than the inner side tapered rollers. This increases the rigidity of the wheel bearing apparatus not only when traveling on a straight road but also on a curved road. Thus, this extends the life of the wheel bearing apparatus.

The outer circumference of the flange ring is formed with stepped cylindrical surfaces. Thus, it has a larger diameter portion facing the wheel mounting flange. The outer side seal is mounted in an annular space formed between a smaller diameter portion of the stepped cylindrical surfaces and the outer member. A slight radial gap is formed between the larger diameter portion of the flange ring and the outer member to form a labyrinth seal. This further improves the sealability of the wheel bearing apparatus.

The wheel bearing apparatus includes a vehicle wheel bearing apparatus that comprises an outer member. The outer member inner circumference has double row tapered outer raceway surfaces that are arranged so that each smaller diameter side faces each other. An inner member includes a wheel hub and an inner ring. The wheel hub has an integrally formed wheel mounting flange. The wheel hub outer circumference surface has one inner raceway surface arranged opposite to one of the double row outer raceway surfaces. A cylindrical portion axially extends from the inner raceway surface. The inner ring is adapted to fit onto the cylindrical portion of the wheel hub, via a predetermined interference. The inner ring outer circumference has another inner raceway surface arranged opposite to the other of the double row outer raceway surfaces. Double row tapered rollers are freely rollably contained between the inner and outer raceway surfaces, respectively, of the inner member and the outer member. Seals are mounted in annular openings formed between the outer member and the inner member. The inner ring has a larger flange formed on its larger diameter side of the inner raceway surface. The larger flange guides the inner side tapered rollers of the double row tapered rollers. No flange is formed on the wheel hub to abut against and guide the larger end faces of the outer side tapered rollers. A flange is formed on the outer member at the outer diameter side of the outer raceway surface to abut against the larger end faces of the outer side tapered rollers and to guide the outer side tapered rollers. A pitch circle diameter of a row of outer side tapered rollers is set larger than the pitch circle diameter of a row of inner side tapered rollers.

The wheel bearing apparatus has a double row tapered roller bearing with no flange formed on the wheel hub to abut against and guide the larger end faces of the outer side tapered rollers. A flange is formed on the outer member at the outer diameter side of the outer raceway surface to abut against the larger end faces of the outer side tapered rollers and to guide the outer side tapered rollers. The pitch circle diameter of the row of outer side tapered rollers is set larger than that of the row of inner side tapered rollers. Thus, it is possible to arrange a larger number of outer side tapered rollers than the number of the inner side tapered rollers. This increases the rigidity of the wheel bearing apparatus not only when traveling on a straight road but also on a curved road. Thus, this extends the life of the wheel bearing apparatus.

A seal land portion has a cross-section that has a substantially circular arc configuration. It is formed at the base portion of the wheel mounting flange. The seal land portion and the inner raceway surface are smoothly connected to each other. This makes it possible to provide sufficient strength and durability to the wheel hub even when a moment load is applied to the wheel mounting flange. Also, this makes it possible to perform simultaneous grinding of the seal land portion and the inner raceway surface by a formed grinding wheel. Thus, this improves the workability of the wheel hub.

The diameter of each outer side tapered roller is smaller than the diameter of each inner side tapered roller. This makes it possible to provide a wheel bearing apparatus that exhibits excellent durability and increase its rigidity while suppressing increases of its weight.

The outer side cage is formed by injection molding of a synthetic resin. This acts to hold the tapered rollers in place and also acts to prevent them from falling out toward the smaller radial side. This makes it possible to eliminate a small flange to hold the tapered rollers at the small diameter side of the inner raceway surface of the wheel hub. Thus, this improves workability of the wheel hub as well as further suppresses increase of the weight of the wheel bearing apparatus.

The inner ring is axially secured on the wheel hub by applying a predetermined pre-load to a caulked portion. The caulked portion is formed by plastically deforming radially outward the end of the cylindrical portion of the wheel hub. This reduces the weight and size of the wheel bearing apparatus and maintains the initially set pre-load for a long term.

The vehicle wheel bearing apparatus comprises an outer member. The outer member inner circumference has double row tapered outer raceway surfaces arranged so that each smaller diameter side faces each other. An inner member includes a wheel hub and an inner ring. The wheel hub has an integrally formed wheel mounting flange. The wheel hub outer circumference has one inner raceway surface arranged opposite to one of the double row outer raceway surfaces. A cylindrical portion axially extends from the inner raceway surface. The inner ring is adapted to be fit onto the cylindrical portion of the wheel hub, via a predetermined interference. The inner ring outer circumference has another inner raceway surface arranged opposite to the other of the double row outer raceway surfaces. Double row tapered rollers are freely rollably contained between the inner and outer raceway surfaces, respectively, of the inner member and the outer member. Seals are mounted in annular openings formed between the outer member and the inner member. The inner ring is formed with a larger flange on its larger diameter side of the inner raceway surface. The larger flange guides the inner side tapered rollers of the double row tapered rollers. A flange ring is fit onto the wheel hub at a place adjacent to the wheel mounting flange to guide the outer side tapered rollers of the double row tapered rollers. The flange ring abuts against the larger end faces of the outer side tapered rollers and guides the outer side tapered rollers. A pitch circle diameter of a row of outer side tapered rollers is set larger than a pitch circle diameter of a row of inner side tapered rollers. Thus, it is possible to arrange a larger number of outer side tapered rollers than that of the inner side tapered rollers. Accordingly, it is possible to increase the rigidity of the wheel bearing apparatus not only when traveling on a straight road but also on a curved road. Thus, this extends the life of the wheel bearing apparatus.

The vehicle wheel bearing apparatus comprises an outer member. The outer member inner circumference has double row tapered outer raceway surfaces arranged so that each smaller diameter side faces each other. An inner member includes a wheel hub and an inner ring. The wheel hub has an integrally formed wheel mounting flange. The wheel hub outer circumference has one inner raceway surface arranged opposite to one of the double row outer raceway surfaces. A cylindrical portion axially extends from the inner raceway surface. The inner ring is adapted to fit onto the cylindrical portion of the wheel hub, via a predetermined interference. The inner ring outer circumference includes another inner raceway surface arranged opposite to the other of the double row outer raceway surfaces. Double row tapered rollers are freely rollably contained between the inner and outer raceway surfaces, respectively, of the inner member and the outer members. Seals are mounted in annular openings formed between the outer member and the inner member. The inner ring is formed with a larger flange on its larger diameter side of the inner raceway surface. The larger flange guides the inner side tapered rollers of the double row tapered rollers. No flange is formed on the wheel hub to abut against and guide the larger end faces of the outer side tapered rollers. A flange is formed on the outer member at the outer diameter side of the outer raceway surface to abut against the larger end faces of the outer side tapered rollers and to guide the outer side tapered rollers. A pitch circle diameter of a row of outer side tapered rollers is set larger than a pitch circle diameter of a row of inner side tapered rollers. Thus, it is possible to arrange a larger number of outer side tapered rollers than that of the inner side tapered rollers. Accordingly, it is possible to increase the rigidity of the wheel bearing apparatus not only when traveling on a straight road but also on a curved road. Thus, this extends the life of the wheel bearing apparatus.

A vehicle wheel bearing apparatus comprises an outer member. The outer member inner circumference has double row tapered outer raceway surfaces arranged so that each smaller diameter side faces each other. An inner member includes a wheel hub and an inner ring. The wheel hub has an integrally formed wheel mounting flange. The wheel hub outer circumference has one inner raceway surface arranged opposite to one of the double row outer raceway surfaces. A cylindrical portion axially extends from the inner raceway surface. The inner ring is adapted to fit onto the cylindrical portion of the wheel hub, via a predetermined interference. The inner ring outer circumference has another inner raceway surface arranged opposite to the other of the double row outer raceway surfaces. Double row tapered rollers are freely rollably contained between the inner and outer raceway surfaces, respectively, of the inner member and the outer member. Seals are mounted in annular openings formed between the outer member and the inner member. The inner ring is formed with a larger flange on its larger diameter side of the inner raceway surface. The larger flange guides the inner side tapered rollers of the double row tapered rollers. A flange ring is fit onto the wheel hub at a place adjacent to the wheel mounting flange to guide the outer side tapered rollers of the double row tapered rollers. The flange ring abuts against the larger end faces of the outer side tapered rollers and guides the outer side tapered rollers. A pitch circle diameter of a row of outer side tapered rollers is set larger than a pitch circle of a row of inner side tapered rollers. The diameter of each outer side tapered roller is smaller than that of each inner side tapered roller.

Further areas of applicability will become apparent from the description provided herein. The description and specific examples in this summary are intended for purposes of illustration only and are not intended to limit the scope of the present disclosure.

### DRAWINGS

Additional advantages and features of the present disclosure will become apparent from the subsequent description and the appended claims, taken in conjunction with the accompanying drawings, wherein:

FIG. 1 is a longitudinal section view of a first embodiment of the vehicle wheel bearing apparatus.

FIG. 2 is a longitudinal section view of a second embodiment of the vehicle wheel bearing apparatus.

FIG. 3 is a longitudinal section view of a prior art vehicle wheel bearing apparatus.

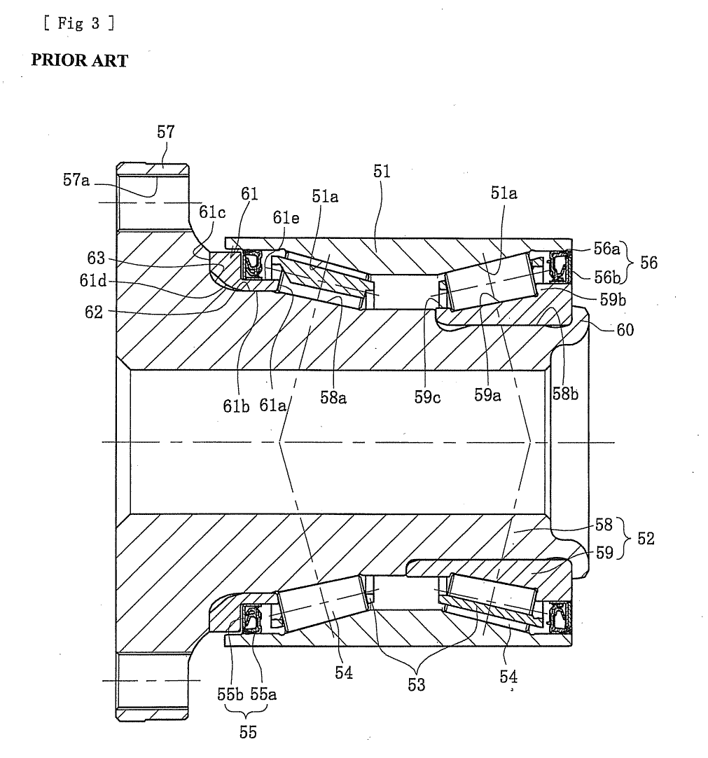

### DETAILED DESCRIPTION

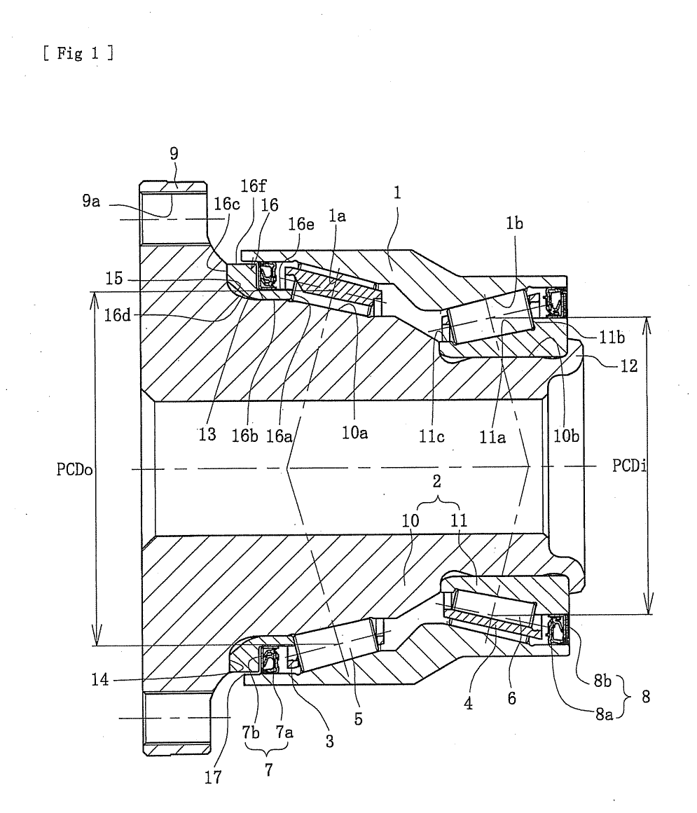

FIG. 1 is a longitudinal section view of a first embodiment of the wheel bearing apparatus. The wheel bearing apparatus is adapted to be mounted on an axle (not shown) of a driven wheel. It has an outer member 1. The outer member 1 inner circumference has double row tapered outer raceway surfaces 1a, 1b arranged so that each smaller diameter side faces each other. An inner member 2 outer circumference has double tapered row inner raceway surfaces 10a, 11a arranged opposite to the double row outer raceway surfaces 1a, 1b, respectively. Double row tapered rollers 5, 6 are freely rollably contained between the inner and outer raceway surfaces, via cages 3, 4. Seals 7, 8 are mounted within annular openings formed between the outer member 1 and the inner member 2. The seals 7, 8 include sealing members 7a, 8a fit in both ends of the outer member 1. Slingers 7b, 8b slidably contact the sealing members 7a, 8a. The seals 7, 8 prevent leakage of lubricating grease sealed within the bearing and the entry of rain water or dusts into the bearing from the outside.

The outer member 1 is made of medium carbon steel including carbon of 0.40˜0.80% by weight such as S53C. The double row outer raceway surfaces 1a, 1b are hardened by high frequency induction quenching to have a surface hardness of 58˜64 HRC.

The inner member 2 includes a wheel hub 10 and an inner ring 11 secured on the wheel hub 10. The wheel hub 10 has at its outer side end an integrally formed wheel mounting flange 9. Bolt apertures 9a are equidistantly formed along the periphery of the wheel mounting flange 9 to receive bolts (not shown) to mount a wheel (not shown) of a vehicle. The wheel hub 10 outer circumstance has outer side inner raceway surface 10a. A cylindrical portion 10b axially extends from the inner raceway surface 10a. The wheel hub 10 is made of medium carbon steel including carbon of 0.40˜0.80% by weight such as S53C. It is hardened by high frequency induction quenching so that a region from a shoulder portion 14, forming the base of the wheel mounting flange 9, to the cylindrical portion 10b, through the inner raceway surface 10a, has a surface hardness of 58˜64 HRC. A caulking portion 12, hereinafter described, remains as is with its surface hardness after forging. It should be noted that any conventional larger flange to guide the tapered rollers 5 is not formed on the larger diameter side of the inner raceway surface 10a of the wheel hub. Instead, a separate flange ring 16, hereinafter described more in detail, is fit onto the wheel hub 10. It should be also noted that any conventional smaller flange to hold the taper rollers is not formed on the smaller diameter side of the inner raceway surface. Instead, the tapered rollers 5 are held by a cage 3 formed by injection molding a synthetic resin. The cage prevents the rollers 5 from falling out toward the smaller diameter side. This improves the workability of the wheel hub 10 and further suppresses an increase in the weight of the bearing apparatus.

The inner ring 11 is press fit onto the cylindrical portion 10b of the wheel hub 10. The inner ring outer circumference has an inner side inner raceway surface 11a. In addition, the inner ring 11 is axially secured on the wheel hub 10 by the caulked portion 12. The caulked portion 12 is formed by plastically deforming the end of the cylindrical portion 10b of the wheel hub 10. This reduces the weight and size of the wheel bearing apparatus and maintains the initially set pre-load for a long term. The inner ring 11 is formed with a larger flange on its larger diameter side of the inner raceway surface 11a. The larger flange 11b abuts against and guides the larger end faces of the inner side tapered rollers 6. The inner ring smaller diameter side of the inner raceway surface 11a is formed with a smaller flange 11c to prevent the tapered rollers 6 from falling out of the inner raceway surface 11a. The slinger 8b, forming part of the inner side seal 8, is fit onto the outer circumference of the larger flange 11b of the inner ring 11. The inner ring 11 and the tapered rollers 5, 6 are made of high carbon chrome steel such as SUJ2. They are hardened to their core by dip quenching to have a surface hardness in a range of 58˜64 HRC.

The circumference of the wheel hub 10 adjacent to the wheel mounting flange 9 is formed with a wheel hub flange ring fitting surface 13. A corner portion 15, with a circular arc cross-section, is formed between the flange ring fitting surface 13 and a shoulder 14. The shoulder 14 is continuous with the side face of the wheel mounting flange 9. A flange ring 16 is fit onto the flange ring fitting surface 13. The flange ring 16 forms a larger flange separate from the wheel hub.

The flange ring 16 is made of high carbon chrome steel such as SUJ2. The flange ring 16 has a flange surface 16a to abut against and guide the larger end faces of the outer side tapered rollers 5. A cylindrical inner circumference 16b is fit onto the wheel hub flange ring fitting surface 13. An end face 16c abuts against the shoulder portion 14 of the wheel mounting flange 9. A chamfered portion 16d, with a predetermined radius of curvature, is formed so that it extends between the end face 16c and the inner circumference 16b so as not to be contacted by a corner portion 15 of the wheel hub. The outer circumference of the flange ring 16 is formed with stepped cylindrical surfaces. Thus, it has a larger diameter portion facing the wheel mounting flange 9. A slinger 7b of the outer side seal 7 is fit onto a smaller diameter portion 16e of the outer circumference. In addition, a slight radial gap is formed between the larger diameter portion 16f of the flange ring 16 and the end of the outer member 1. It forms a labyrinth seal 17 to further improve the sealability of the seal 7. The flange ring 16 is hardened to its core by dip quenching to have a hardness within a range of 58˜64 HRC.

The larger flange conventionally formed on the larger diameter side of the inner raceway surface of the wheel hub is replaced by the flange ring 16 that is separate from the wheel hub 10. The ring 16 is fit onto the outer circumference of the wheel hub 10 adjacent to the wheel mounting flange 9. Thus, it is possible to suppress stress concentration, which would be caused at a region near a boundary between the inner raceway surface 10a and the flange surface 16a of the flange ring 16, by contact of the tapered rollers 5 with the boundary region. Thus, fatigue in the boundary region would be scarcely caused even though the wheel bearing apparatus is applied to a heavy duty vehicle. In addition, the chamfered portion 16d of the flange ring 16 does not contact the corner portion 15 of the shoulder portion 14. Thus, it is possible to further reduce the stress concentration caused by the load applied by the tapered rollers 5 via the flange ring 16.

A pitch circle diameter PCDo of a row of outer side tapered rollers 5 is set larger than the pitch circle diameter PCDi of a row of inner side tapered rollers 6. The diameter of each outer side tapered roller 5 is smaller than that of each inner side tapered roller 6. In accordance with this structure, the diameter of the inner raceway surface 10a of the wheel hub 10 is made larger than the diameter of the inner raceway surface 11a of the inner ring 11. Also, the diameter of the outer side outer raceway surface 1a of the outer member 1 is made larger than the diameter of the inner side outer raceway surface 1b. In addition, the number of outer side tapered rollers 5 is larger than the number of the inner side tapered rollers 6. The pitch circle diameter PCDo of the row of outer side tapered rollers 5 is larger than the pitch circle diameter PCDi of the row of inner side tapered rollers 6 (PCDo>PCDi). Thus, it is possible to increase the rigidity of the wheel bearing apparatus not only when traveling on a straight road but on a curved road. Thus, this extends the life of the wheel bearing apparatus. Furthermore, since the diameter of each outer side tapered roller 5 is smaller than that of each inner side tapered roller 6, it is possible to provide a wheel bearing apparatus that can exhibit excellent durability and increase its rigidity while suppressing an increase of its weight.

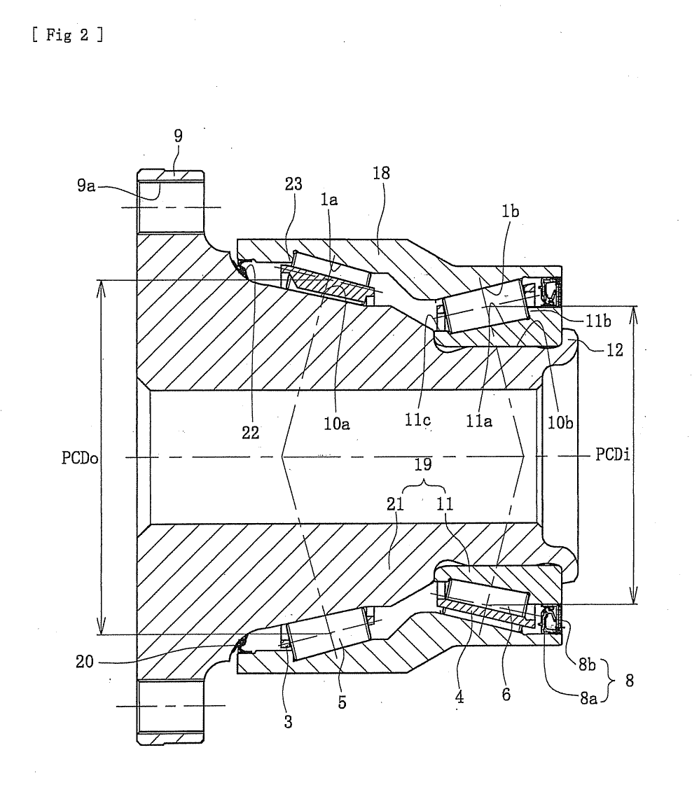

FIG. 2 is a longitudinal section view of a second embodiment of the wheel bearing apparatus. The same reference numerals as those used in the first embodiment are also used in this embodiment to designate the same components.

The wheel bearing apparatus is adapted to be mounted on an axle (not shown) of a driven wheel. It has an outer member 18. The outer member inner circumference has double row tapered outer raceway surfaces 1a, 1b arranged so that each smaller diameter side faces each other. An inner member 19 outer circumference has double tapered row inner raceway surfaces 10a, 11a arranged opposite to the double row outer raceway surfaces 1a, 1b, respectively. Double row tapered rollers 5, 6 are freely rollably contained between the inner and outer raceway surfaces, via cages 3, 4. Seals 20, 8 are mounted within annular openings formed between the outer member 18 and the inner member 19. The outer side seal 20 is a unit type seal fit within the end of the outer member 18. The outer seal 20 in cooperation with the inner side seal 8, formed as a pack seal, prevent leakage of lubricating grease sealed within the bearing and the entering of rain water or dusts into the bearing from the outside.

The outer member 18 is made of medium carbon steel including carbon of 0.40˜0.80% by weight such as S53C. The double row outer raceway surfaces 1a, 1b are hardened by high frequency induction quenching to have a surface hardness of 58˜64 HRC.

The inner member 19 includes a wheel hub 21 and an inner ring 11 secured onto the wheel hub 21. The wheel hub 21 has at its outer side end an integrally formed wheel mounting flange 9. The wheel hub outer circumstance has outer side inner raceway surface 10a. A cylindrical portion 10b axially extends from the inner raceway surface 10a.

The wheel hub 21 is made of medium carbon steel including carbon of 0.40˜0.80% by weight such as S53C. It is hardened by high frequency induction quenching so that a region from a seal land portion 22, having a substantially circular arc cross-section forming the base of the wheel mounting flange 9, to the cylindrical portion 10b, through the inner raceway surface 10a, has a surface hardness of 58˜64 HRC. It should be noted that any conventional larger flange for guiding the tapered rollers 5 is not formed on the larger diameter side of the inner raceway surface 10a of the wheel hub. Instead, a flange 23, hereinafter described more in detail, is formed on the outer member 18. It should be also noted that any conventional smaller flange for holding the taper rollers is not formed on the smaller diameter side of the inner raceway surface. Instead, the tapered rollers 5 are held by a cage 3, formed by injection molding a synthetic resin, to prevent the rollers 5 from falling out toward the smaller diameter side. This improves the workability of the wheel hub 21 and further suppresses an increase of the weight of the bearing apparatus.

In the second embodiment, the flange 23 for guiding the outer side tapered rollers 5 is formed on the outer member 18. The flange 23 to abut against the larger end faces of the tapered rollers 5 and guide them is integrally formed on the larger diameter side of the outer side outer raceway surface 1a of the outer member 18. This enables to simultaneously grind the seal land portion 22, forming the base of the wheel mounting flange 9, and the inner raceway surface 10a by a formed grinding wheel. Thus, the surfaces are smoothly connected with each other. Accordingly, the stress concentration to the wheel hub can be suppressed. Thus, it is possible to suppress the generation of fatigue in the wheel hub 21 and to improve the strength and durability of the wheel bearing apparatus even though it is applied onto a heavy duty vehicle and large moment loads are applied to the wheel mounting flange 9.

Similarly to the first embodiment, the pitch circle diameter PCDo of the row of outer side tapered rollers 5 is set larger than the pitch circle diameter PCDi of the row of inner side tapered rollers 6. The diameter of each outer side tapered roller 5 is smaller than that of each inner side tapered roller 6 in this second embodiment. In accordance with this structure, the diameter of the inner raceway surface 10a of the wheel hub 21 is made larger than that of the inner raceway surface 11a of the inner ring 11. The diameter of the outer side outer raceway surface 1a of the outer member 18 is made larger than that of the inner side outer raceway surface 1b. In addition, the number of outer side tapered rollers 5 is larger than the number of the inner side tapered rollers 6. The pitch circle diameter PCDo of the row of outer side tapered rollers 5 is larger than the pitch circle diameter PCDi of the row of inner side tapered rollers 6 (PCDo>PCDi). Thus, it is possible to increase the rigidity of the wheel bearing apparatus not only when traveling on a straight road but on a curved road. Thus, this extends the life of the wheel bearing apparatus. Furthermore, since the diameter of each outer side tapered roller 5 is smaller than that of each inner side tapered roller 6, it is possible to provide a wheel bearing apparatus that exhibits excellent durability and increase its rigidity while suppressing an increase of its weight.

The present disclosure has been described with reference to the preferred embodiments. Obviously, modifications and alternations will occur to those of ordinary skill in the art upon reading and understanding the preceding detailed description. It is intended that the present disclosure be construed as including all such alternations and modifications insofar as they come within the scope of the appended claims or their equivalents.

The wheel bearing apparatus of the present disclosure can be applied to a wheel bearing apparatus for a driving wheel or a driven wheel that can rotationally support the wheel by a double row tapered roller bearing.

What is claimed is:

1. A vehicle wheel bearing apparatus comprising:
an outer member on its inner circumference has double row tapered outer raceway surfaces arranged so that each smaller diameter side faces toward each other;
an inner member including a wheel hub and an inner ring, the wheel hub has an integrally formed wheel mounting flange, said wheel hub outer circumference has one inner raceway surface arranged opposite to one of the double row outer raceway surfaces and a cylindrical portion axially extends from the inner raceway surface, the inner ring adapted to be fit onto the cylindrical portion of the wheel hub via a predetermined interference and said inner ring outer circumference has another inner raceway surface arranged opposite to the other of the double row outer raceway surfaces;
double row tapered rollers freely rollably contained between the inner and outer raceway surfaces, respectively, of the inner member and the outer member;
seals mounted in annular openings formed between the outer member and the inner member;
the inner ring has a large flange on its larger diameter side of the inner raceway surface, said larger flange for guiding the inner side tapered rollers of the double row tapered rollers;
a flange ring fit onto the wheel hub at a place adjacent to the wheel mounting flange for guiding the outer side tapered rollers of the double row tapered rollers, said flange ring abutting against the larger end faces of the outer side tapered rollers and guiding the outer side tapered rollers; and
a pitch circle diameter of a row of outer side tapered rollers is set larger than that a pitch circle diameter of a row of inner side tapered rollers.

2. The vehicle wheel bearing apparatus of claim 1 wherein the outer circumference of the flange ring has stepped cylindrical surfaces so that it has a larger diameter portion facing the wheel mounting flange, and the outer side seal is mounted in an annular space formed between a smaller diameter portion of the stepped cylindrical surfaces and the outer member; and a slight radial gap is formed between the larger diameter portion of the flange ring and the outer member to form a labyrinth seal.

3. The vehicle wheel bearing apparatus claim 1, wherein the diameter of each outer side tapered roller is smaller than that of each inner side tapered roller.

4. The vehicle wheel bearing apparatus of claim 1, wherein the outer side cage is formed by injection molding of a synthetic resin, said cage acts to hold the tapered rollers and said tapered rollers from falling out toward a radially smaller side.

5. The vehicle wheel bearing apparatus of claim 1, wherein the inner ring is axially secured on the wheel hub with a predetermined pre-load by a caulked portion, said caulked portion formed by plastically deforming radially outward an end of the cylindrical portion of the wheel hub.

6. The vehicle wheel bearing apparatus comprising:
an outer member on its inner circumference has double row tapered outer raceway surfaces arranged so that each smaller diameter side faces toward each other;
an inner member including a wheel hub and an inner ring, the wheel hub having an integrally formed wheel mounting flange, the wheel hub outer circumference has one inner raceway surface arranged opposite to one of the double row outer raceway surfaces and a cylindrical portion axially extending from the inner raceway surface, the inner ring adapted to be fit onto the cylindrical portion of the wheel hub, via a predetermined interference, and the inner ring outer circumference has another inner raceway surface arranged opposite to the other of the double row outer raceway surfaces;
double row tapered rollers freely rollably contained between the inner and outer raceway surfaces, respectively, of the inner member and the outer member; and
seals mounted in annular openings formed between the outer member and the inner member;
the inner ring is formed with a larger flange on its larger diameter side of the inner raceway surface, said larger flange for guiding the inner side tapered rollers of the double row tapered rollers; no flange is formed on the wheel hub for abutting against and guiding the larger end faces of the outer side tapered rollers;
a flange formed on the outer member at the outer diameter side of the outer raceway surface for abutting against and guiding the larger end faces of the outer side tapered rollers;
a pitch circle diameter of a row of outer side tapered rollers is set larger than a row of inner side tapered rollers.

7. The vehicle wheel bearing apparatus of claim 6 wherein a seal land portion, with a cross-section of substantially circular arc configuration, is formed at the base portion of the wheel mounting flange, and the seal land portion and the inner raceway surface are smoothly connected to each other.

8. The vehicle wheel bearing apparatus claim 6, wherein the diameter of each outer side tapered roller is smaller than that of each inner side tapered roller.

9. The vehicle wheel bearing apparatus of claim 6, wherein the outer side cage is formed by injection molding of a synthetic resin, said cage acts to hold the tapered rollers and said tapered rollers from falling out toward a radially smaller side.

10. The vehicle wheel bearing apparatus of claim 6, wherein the inner ring is axially secured on the wheel hub with a predetermined pre-load by a caulked portion, said caulked portion formed by plastically deforming radially outward an end of the cylindrical portion of the wheel hub.
